(19) United States
(12) Patent Application Publication
(10) Pub. No.: US 2010/0045609 A1
(43) Pub. Date: Feb. 25, 2010

(54) METHOD FOR AUTOMATICALLY CONFIGURING AN INTERACTIVE DEVICE BASED ON ORIENTATION OF A USER RELATIVE TO THE DEVICE

(75) Inventors: Lydia Mai Do, Raleigh, NC (US); Travis M. Grigsby, Austin, TX (US); Pamela Ann Nesbitt, Tampa, FL (US); Lisa Anne Seacat, San Francisco, CA (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 12/194,752

(22) Filed: Aug. 20, 2008

(51) Int. Cl. G06F 3/041

(52) U.S. Cl. 345/173

(57) ABSTRACT

A method and apparatus are provided for use in association with a computer operated interactive device having a surface, wherein the interactive device is responsive to contact between its surface and persons or objects, and is adapted to selectively display images upon its surface. One embodiment, comprising a method, includes enabling the interactive device to access specified information pertaining to the user. Also, the device is selectively configured for interaction with a user, during a time related to performance of a specified activity. The method further includes using at least some of the specified user information to determine the orientation of the user with respect to a reference position of the surface, at a time related to performance of the specified activity. The method also includes performing a task, wherein performance of the task is related to the determined user orientation.

### BACKGROUND OF THE INVENTION

1. Field of the Invention

The invention disclosed and claimed herein generally pertains to a method whereby a user of an interactive device selectively contacts a surface of the device, while performing a specified activity. More particularly, the invention pertains to a method of the above type wherein the orientation of the user with respect to the device is automatically determined, initially and/or during the performance. Even more particularly, the invention pertains to a method of the above type wherein the interactive device may be selectively configured or adjusted, and actions of the user may be interpreted, based on the determined user orientation.

2. Description of the Related Art

In recent years, there have been significant developments in the tools that are available for enabling computer users to interact with their computers. For example, in addition to a mouse, keyboard or gaming controller, a user can interact with a computer by selectively touching locations on a display screen. Also, computer operated dance mats have been developed, which are intended for placement on a floor. In the use of such devices, an adjacent screen displays a succession of arrow images or the like, accompanied by music, and users attempt to place their feet on the mat according to the arrows.

More recently, motion sensing technology has been developed for computer gaming systems, which can monitor and respond to a wide range of human body motions, including arm, leg, and hand motions. Even more recently, systems such as the Microsoft Surface Computer have been developed, which uses multiple cameras to acquire information from human hands and other objects that are placed and moved upon a contact surface.

A drawback to interactive systems such as those described above is that the orientation of the user, with respect to a system reference position such as a position on a contact surface thereof, must frequently be known in order to use the system successfully. For example, in using dance mats of the type described above, the system assumes that a user is facing toward the adjacent screen. The displayed succession of images is based on this orientation, and would not make sense if the user was facing in a different direction. Accordingly, it would be beneficial for the correct orientation of a user, with respect to a system reference position, to be readily determined.

Moreover, human users vary widely in height, weight and other body dimensions. However, the physical structure with which all users must interact, when operating an interactive device or system, is typically of one size, or has a single set of metrics. It would thus be beneficial, if the structure of such systems could be readily scaled or configured to match the respective sizes of different individual users.

### BRIEF SUMMARY OF THE INVENTION

A method and apparatus are provided for use in association with a computer operated interactive device having a surface, wherein the interactive device is responsive to contact between its surface and persons or objects, and is adapted to selectively display images upon its surface. One embodiment, comprising a method, includes enabling the interactive device to access specified information pertaining to the user. Also, the device is selectively configured for interaction with a user during a time related to a specified activity by the user. The method further includes using at least some of the specified user information to determine the orientation of the user with respect to a reference position of the surface, during a time related to performance of the specified activity. The method also includes performing a task, wherein performance of the task is related to the determined user orientation.

### BRIEF DESCRIPTION OF THE SEVERAL VIEWS OF THE DRAWINGS

FIG. 1 is a schematic diagram illustrating components of a system that may be used in implementing an embodiment of the invention.

FIG. 2 is a block diagram showing a data processing system which may be used to provide one or more components for the system of FIG. 1.

FIG. 3 is a schematic diagram illustrating components of a system that may be used in implementing a further embodiment of the invention.

FIG. 4 is a schematic diagram illustrating further operation of the embodiment of FIG. 3.

FIG. 5 is a schematic diagram illustrating yet another embodiment of the invention.

FIG. 6 is a flowchart showing principal steps for a method comprising an embodiment of the invention.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

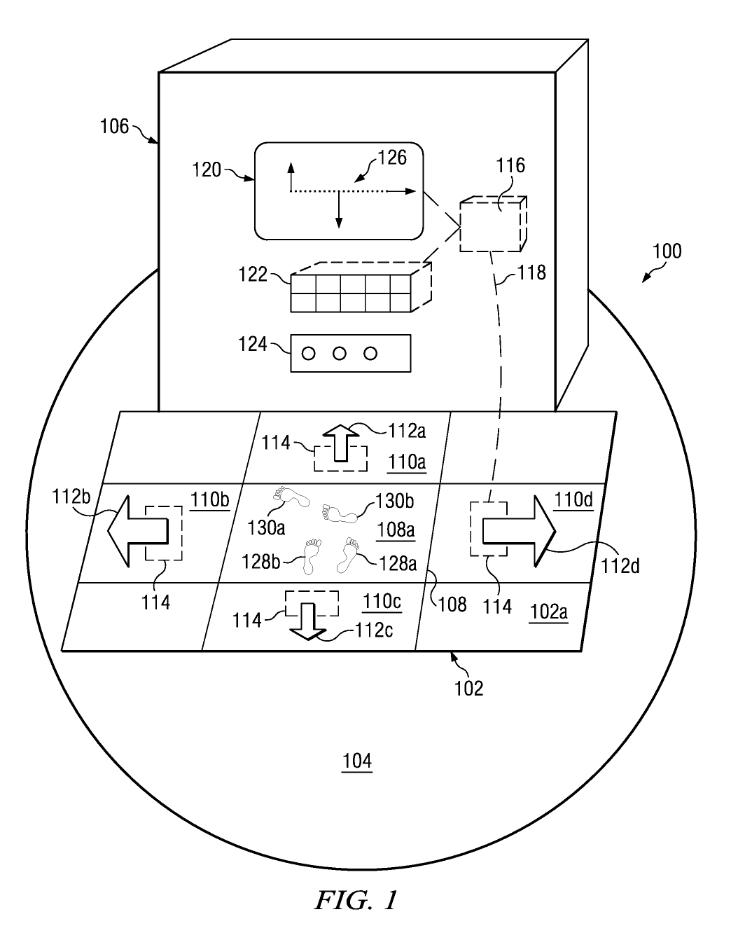

Referring to FIG. 1, there is shown a generalized interactive machine 100, of a type which is similar to machines found in arcades, and operated by users in performing dance routines. Machine 100, however, has been adapted to implement embodiments of the invention, and is also not limited to use in arcade environments. Machine 100 is provided with two principal components, a pad or mat 102, intended for placement on a floor 104 or other solid horizontal surface, and a control console 106.

Pad 102 has a surface 102a and is divided into a number of sections, including a central section comprising a device 108 having a surface 108a, and four side sections 110a-d. Side sections 110a-d are each adjacent to the central section, but are respectively oriented in different directions therefrom. Side sections 110a-d are also provided with arrow images 112a-d, respectively, although images of other shapes or forms could alternatively be used. The pad 102 is further provided with a number of electronic pressure sensors 114, wherein each pressure sensor is located directly beneath one of the arrows 112a-d. Accordingly, whenever a user places a foot on one of the arrows 112a-d, and thus applies pressure to the corresponding sensor 114, the sensor will produce an electronic signal in response.

Referring further to FIG. 1, there is shown control console 106 provided with a control computer or data processing system 116. Respective signals produced by the sensors 114 are coupled to computer 116 through conductors such as conductor 118, embedded in the pad 102 beneath surface 102a, and extending between computer 116 and the sensor 114 for section 110d (conductors for the sensors of other sections are not shown). Computer 116 is also connected to operate a video display 120 and an audio device 122, and controls 124 are provided for manual adjustment of machine 100.

In conventional operation, computer 116 drives display 120 to present a sequence of arrow symbols 126 to a user (not shown) standing on pad 102, wherein each symbol corresponds to one of the arrows 112a-d. The user attempts to follow the presented sequence, by placing one of her/his feet on the arrow of the correct side section of pad 102, each time a new symbol is presented. This activity is usually accompanied by appropriate music, generated by audio device 122.

In a departure from such conventional operation, and in accordance with an embodiment of the invention, a sequence 126 is initially not presented to a user of machine 100. Instead, the user initially performs a dance routine as an input to machine 100. As the user performs successive steps of the routine, her/his feet are sequentially placed on respective arrows 112a-d. The resulting pattern of arrow signals, generated by sensors 114 during the initial performance, are recorded and stored by computer 116. Then, at some later time computer 116 can be operated to reproduce the pattern of the arrow sequence. Thus, the same or a different user could recreate the initial performance.

By providing the capability to record and then later recreate a dance performance, a dance teacher could initially perform an intricate or difficult routine. The routine could then be presented to a student using machine 100, by means of an appropriate sequence of symbols 126. The student would perform the routine by following the sequence of symbols 126, and sensors 114 would provide a record of her/his performance. Usefully, computer 116 could also be configured to automatically compare and analyze the record of the student performance with the teacher performance. Such comparison could, for example, indicate how much difference there was between a teacher and student in regard to metrics related to timing, accuracy or precision.

In a further application, subsequent performances of a dance routine by a user of machine 100 could be compared with an initial performance by the same user. Analysis of the subsequent performances could provide the user with a quantitative measure of the extent to which her/his performance was improving.

Additional embodiments of the invention could be directed to human activity involving other types of movements besides dancing, such as movements pertaining to various kinds of sports. For example, currently available motion sensing devices could be used to record an initial performance of such activity, and then record a subsequent performance of the activity for comparison, as described above. Other embodiments could pertain to interactive devices that have touch screens, which respond to contact by human hands or handheld objects at different locations on the screen.

Referring further to FIG. 1, there are shown the right and left shoeprints 128a and 128b, respectively, of a user (not shown) of machine 100, wherein the shoeprints are positioned on the device 108. The direction the user is facing, as shown by shoeprints 128a-b, indicates the orientation of the user with respect to machine 100 and to arrows 112a-d. For example, shoeprints 128a-b as shown by FIG. 1 indicate that the user is facing console 106. Accordingly, arrow 112d is to the user's right and arrow 112b is to the user's left. However, if the user was facing in the opposite direction, arrows 112d and 112b would be to the user's left and right, respectively.

It is to be appreciated that in order to have a successful interaction between a user and machine 100, it is absolutely essential for machine 100 to be apprised of the correct orientation of the user, with respect to console 106 and surface 102a. Accordingly, device 108 usefully comprises a device, such as a MICROSOFT® Surface computer device, which is capable of scanning and analyzing, in great detail, a wide range of objects that are placed on its surface. It is anticipated that such device 108, acting together with computer 116, could recognize that objects 128a-b were in fact human shoeprints. The device 108 could also determine, by considering the two shoeprints together, the correct orientation of the person associated with the shoeprints with respect to machine 100 and pad surface 102a. More particularly, the device could determine from the two shoeprints whether the person was facing the direction indicated by arrow 112a, or was facing in the direction indicated by one of the other three arrows 112b-d.

In recording the initial performance of a dance routine as described above, it will generally be necessary to know the orientation of the performer, or direction the performer is facing, at the beginning of the performance. By providing the above capability of device 108, this information can be furnished automatically. The performer simply begins the performance by standing on the surface 108a of device 108, facing in any direction. The device 108 and computer 116 then determine this direction as described above, and reference the performance with respect to such direction.

At the beginning of a subsequent performance, the performer again stands on device 108, and her/his initial orientation is determined. If her/his initial orientation is different from the initial orientation of the first performance, computer 116 will automatically adjust or modify the presentation of symbols 126, in order to compensate for such difference. For example, if the initial performance begins with a user facing in the direction of arrow 112a, and the subsequent performance begins with the user facing in the opposite direction, along arrow 112c, computer 126 could adjust sequence 126 by reversing the directions of successive presented arrows.

Referring further to FIG. 1, there are shown right and left shoeprints 130a and b, respectively, on surface 108a of device 108, wherein prints 130a and b are identical to shoeprints 128a and b, respectively. However, shoeprint 130b follows shoeprint 130a, and the two prints together clearly indicate that the person associated therewith is moving in the direction indicated by arrow 112b. Timing information provided by device 108 could also confirm that contact with surface 108a, represented by shoeprint 130a, occurred after contact represented by shoeprint 130b. This timing information would further support a conclusion that movement is in the direction of arrow 112b.

It is considered that information of the type provided by shoeprints 130a and 130b together could be used to further indicate the orientation of a user, while a dance routine is being performed or is in process. If the user is following a pre-specified dance pattern, that is guided or directed by computer 116, computer 116 is able to determine whether the orientation of the user, as shown by shoeprints 130a and 130b, matches the orientation as understood by the computer. If not, the computer can make adjustments to the directions that it subsequently provides to the user.

It is considered further that the device 108 could acquire precise measurements of shoeprints 128a and 128b, as well as other information that clearly identified them. This information could be stored in computer 116 or the like, together with the identity of the user associated with the shoeprints. A profile of other information pertaining to this user could also be stored, together with such user's identity. Thereafter, if the user again uses machine 100, machine 100 could scan the user's shoeprints and automatically identify the user, using the previously stored measurement information. Also, it is recognized that dancing is frequently performed without shoes. It is considered that device 108 could recognize the right and left footprints of individual users, as well as their shoeprints.

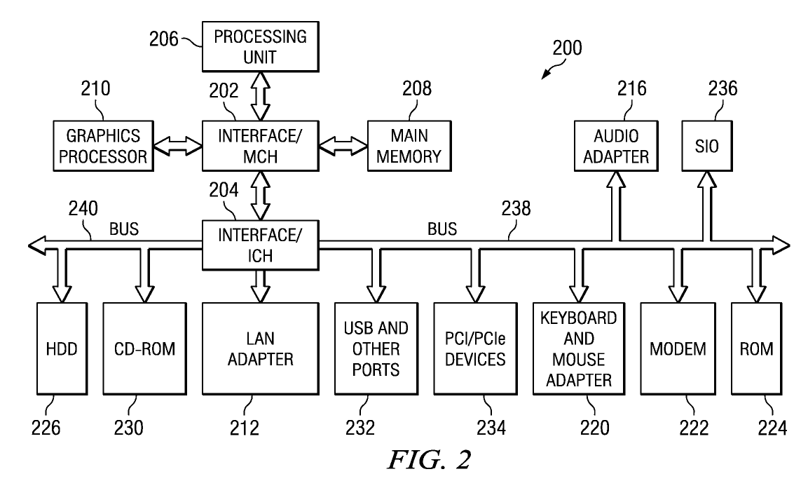

With reference to FIG. 2, a block diagram of a data processing system 200 is shown in which aspects of the present invention may be implemented. Data processing system 200 is an example of a computer, such as computer 116 of FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

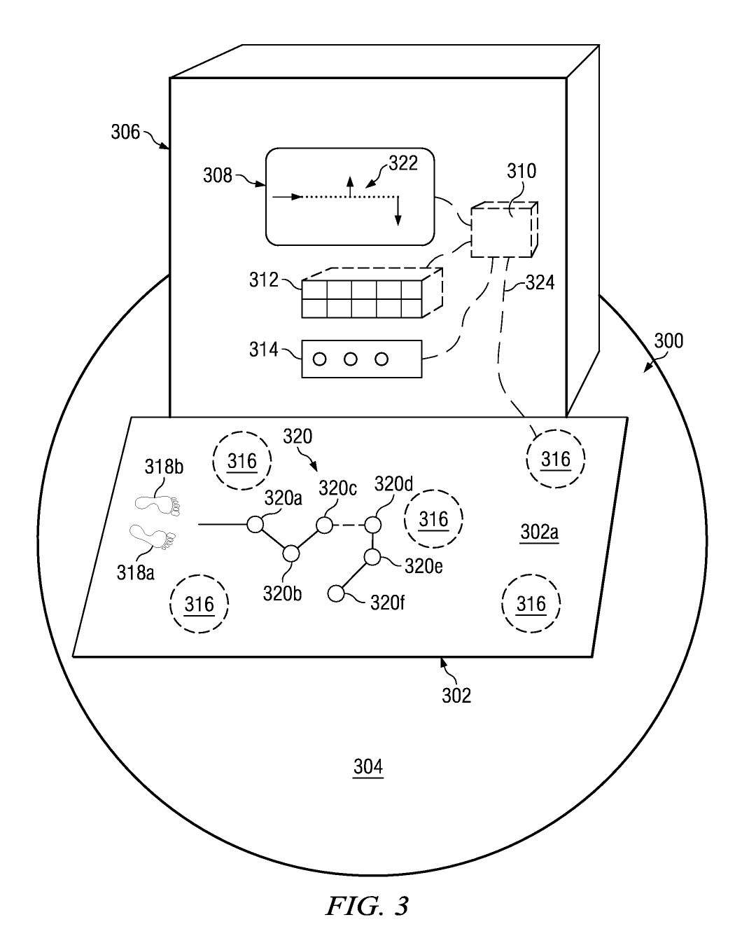

Referring to FIG. 3, there is shown a machine 300 for implementing a further embodiment of the invention, wherein machine 300 is disposed to monitor and provide guidance or direction for dance routines, somewhat in the manner of machine 100 described above. Machine 300 comprises a dance surface device 302, supported with respect to a floor 304 or other horizontal surface, and a console 306. Console 306 is provided with a control computer 310, which may comprise a computer or data processing system 200 as described above in connection with FIG. 2. Console 306 is further provided with a video display 308 and an audio device 312 that are operated by computer 310, and with controls 314 for manually adjusting machine 300.

Referring further to FIG. 3, there is shown device 302 having a surface 302a that is similar to the surface 108a of device 108, described above in connection with FIG. 1. However, surface 302a has an area comparable to the entire area of pad 102, and is thus substantially larger than the area of surface 108a. Device 302 also comprises a device that is similar to the device 108 described above, but is both large enough and strong enough for the performance of an entire dance routine.

FIG. 3 further shows a number of cameras 316 beneath the surface 308a of device 308, wherein the cameras are disposed to detect infrared light or other radiation from objects placed on surface 302a, such as a dancer's feet or shoes. Accordingly, when a user is performing a dance routine on device 302, each time one or both of the user's feet contacts the surface 302a, the time and location of contact is detected by the collective action of the cameras 316. Successive contacts that occur during the dance performance are recorded by computer 310 or the like, and stored thereby for use in re-creating the performance. Signals produced by the cameras 316 are coupled to computer 310 through conductors such as conductor 324 (conductors for the other cameras are not shown).

It is to be appreciated that using device 302, rather than the pad 102 of machine 100, provides significant advantages to a user. For example, a user can dance much more freely on device 302, without being concerned about whether she/he steps within the pad areas required to activate sensors 114. As a result, dance movements can be much more natural and unrestrained. In one embodiment, surface 302a could be the surface of a single device 302. In another embodiment, device 302 could be constructed by placing a number of devices, such as Microsoft Surface devices, in abutting relationship with one another. For example, nine of such devices could be placed together to provide the requisite dance area.

FIG. 3 shows shoeprints 318a and b of a user, positioned to establish the orientation of the user prior to commencing a dance routine. As described above in connection with device 108, cameras 316 and computer 310, by their collective action, are able to recognize from shoeprints 318a and b that the user is oriented so that console 306 is to her/his left. The user then performs a dance routine 320, where 320a-f each represents a contact between surface 302a and a shoe of the user. Contacts 320a-c occur at the beginning of the performance, and contacts 320d-f occur at the end thereof. The time and location of each contact, as sensed by cameras 316, is recorded and stored in computer 310. In the arrangement of FIG. 1, dance movements are generally limited to the four diagonal directions indicated by arrows 112a-d. However, pad 302 does not impose such limitations. Thus, FIG. 3 shows that exemplary movements from contact 320a to contact 320b, and from contact 320e to 320f, are along diagonal directions, rather than one of four orthogonal directions.

After recording an initial dance performance, a sequence of symbols 322 can be presented to guide and direct a subsequent performance, as described above in connection with machine 100. Once again, the subsequent performance can be carried out by the same performer, or by a different performer such as a student. Also, device 302 is operable to automatically determine the orientation of a user during a performance, as well as at the beginning of the performance, by acquiring a pattern of right and left shoeprints. The orientation information can be used to adjust subsequent directions provided to the user, as described above.

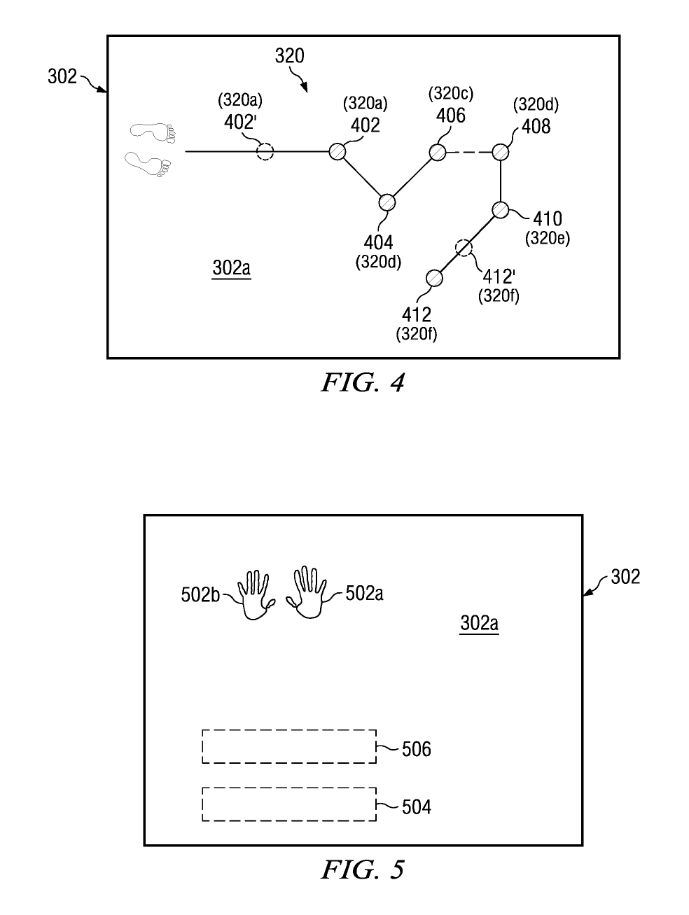

Referring to FIG. 4, there is shown the dance routine 320 being re-created for a subsequent performance, based on the initial performance. More particularly, at the location of each contact 320a-f, device 302 displays a respectively corresponding point of light or illumination 402a-f on surface 302a. Each point of light is displayed in the same sequence, and with the same timing, as the corresponding contacts 320a-f occurred in the initial performance, as respectively shown by FIG. 3. Thus, a user carrying out the subsequent performance can follow the successively produced points of light. Moreover, the orientation of the displayed points of light can be adjusted according to the detected orientation of the user.

In the same manner as described above in connection with FIG. 1, machine 300 can recognize and identify different users, by analyzing the dimensions and other characteristics of their shoeprints or footprints. Usefully, size or physical characteristics of different users are stored by computer 310, together with their respective identities and other profile information. Thus, if computer 310 is informed of the identity of a subsequent performer of routine 320, and recognizes that such performer is different from the person that carried out the routine 320 initially, computer 310 can scale the subsequent performance, to adjust for differences between the two performers. For example, if the subsequent performer was significantly smaller then the initial performer, and thus had shorter steps, the light point for contact 320a could be provided at location 402′, as shown by FIG. 4, rather than 402. Similarly, the light point for contact 320f could be provided at 412′ rather than 412.

In another embodiment of the invention, machine 300 and device 302 could be adapted to lead a person in an exercise routine, by showing them where to place their feet and/or hands. This could be achieved by flashing lights or other illumination on surface 302a of device 302. For example, after a user has been identified to machine 300 and has indicated her/his orientation spatially with respect to pad 302, the surface 302a could show images 502a and 502b, of two adjacent spread hands. The surface 302a would also display a box 504 or the like, where the user is to place her/his feet. The user would understand from the combined images 502a-b and 504 that she/he is to do pushups.

Information for locating the images 502a-b and 504 may be tailored to information that is specific to the user, such as user height, weight, or age. By showing such images, the device 302 can assure that the push ups are being done correctly, and thus minimize potential injury and ensure a good workout. Moreover, device 302 can sense information, such as pulse and temperature, and such information may be used to determine when a user is becoming fatigued. Machine 300 can then change the workout to do less of a particular exercise, or to direct the user to an exercise requiring lower effort.

FIG. 5 further shows a box 506, to further illustrate how device 302 can be scaled or adapted, in order to provide a push up position for a person recognized to be shorter than the person using box 504.

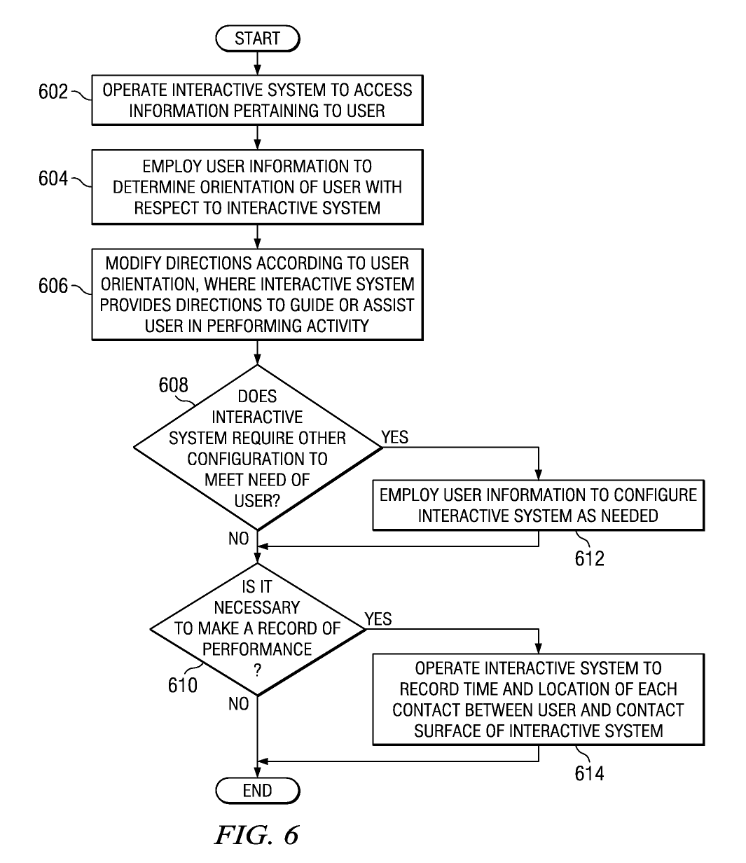

Referring to FIG. 6, there are shown some selected steps of a method comprising an embodiment of the invention. At step 602 an interactive system, such as machine 300 described above, is operated to access information pertaining to a user, wherein the user intends to engage in an interactive performance or other activity with respect to the system. Usefully, prespecified information that is related to the particular activity is stored by the system for multiple users, and is automatically accessed for a user when the user is identified. Users could manually identify themselves, by inputting their names or identity codes into the system. Alternatively, the system could acquire biometric information from the user, such as by scanning her/his handprints, shoeprints or footprints, and then comparing such information against a profile for each person stored in the system database.

At step 604, user information is used to determine the orientation of the user relative to the system, such as relative to a reference position on an interactive surface. This may be done automatically as described above, by scanning user shoeprints or footprints. The system would then interpret the scanned information, in order to resolve user orientation. (Probably need to discuss how the shoeprints would be used to establish orientation. What about odd shapes? What about big-footed, but small user? Discussion about spacing of shoeprints. I am not sure if history of user movement is used to establish profile or user measurements or keyboard input.)

At step 606, user orientation is used to modify as necessary any directions that are provided to the user, in order to guide or assist the user in performing the intended activity. Such directions could include, for example, the displaying of successively illuminated points 402a-f described above. In one mode, user orientation would be determined just before beginning the activity, and modifications specified by step 606 would be made at that time. In another mode, user orientation would be monitored during performance of the activity, and corresponding modifications or adjustment of directions for the user would then be made.

Referring further to FIG. 6, step 608 is directed to determining whether any other adjustment or configuration of the interactive system is necessary, in regard to an intended performance. For example, if a student intends to perform the dance routine 320, described above in connection with FIGS. 3 and 4, it could be determined at step 608 that guiding lightpoints such as 420a-f should be scaled or adjusted to the size of the student. This would be carried out at step 612. If it was determined at step 608 that no further configuration was needed, the method would proceed to step 610, to decide whether or not it was necessary to make a record of the user's performance. If not, the method of FIG. 6 would end. Otherwise, the method would proceed to step 614, and the interactive system would be operated to record time and location of each contact between the user and the contact surface on the interactive system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In association with a computer operated interactive device having a surface, wherein the interactive device is responsive to contact between its surface and respective persons and objects, and is adapted to selectively display images upon its surface, a method comprising the steps of:
enabling said interactive device to access specified information pertaining to a user;
selectively configuring said device for interaction with said user, during a time related to performance of a specified activity by said user;
using at least some of said specified user information to determine the orientation of said user with respect to a reference position of said surface, at a time related to performance of said specified activity; and
performing a task that is related to the determined orientation of said user with respect to said reference position of said surface.

2. The method of claim 1, wherein said method includes the step of:
recording each of a succession of contacts that are applied to said surface by said user, when said user is performing said activity, wherein said contacts collectively comprise a record of said performance.

3. The method of claim 2, wherein:
said task includes selectively adjusting said record of said performance in accordance with said determined orientation of said user, and said adjusted performance record is compared with a prespecified standard of performance.

4. The method of claim 3, wherein:
said prespecified standard of performance is used in providing said user with real time directions.

5. The method of claim 2, wherein:
said prespecified standard of performance is generated by a user performing an activity selected from a group of activities that include at least a specified dance routine, a physical activity and exercise.

6. The method of claim 1, wherein:
said interactive device stores information pertaining to each of a plurality of users, and said device is operable to identify a particular user, and to access stored information of the identified particular user.

7. The method of claim 1, wherein:
one or more specified images are displayed on said surface when said user is performing said specified activity, and said task related to the orientation of said user comprises visually changing images displayed on the surface in respect to the orientation of said user.

8. The method of claim 7, wherein:
one or more of said displayed images each corresponds to one of a succession of contacts applied to said surface by a user, during a prior performance of said specified activity.

9. The method of claim 1, wherein:
said configuring step includes adjustment of real time directions provided to said user, in response to one or more size related dimensions of said user, wherein said size related dimensions are included in said specified user information.

10. The method of claim 1, wherein:
said user orientation is automatically determined one or more times, while said user is performing said specified activity.

11. The method of claim 1, wherein:
said user orientation is automatically determined at the beginning of a performance of said specified activity.

12. The method of claim 1, wherein:
said orientation is automatically determined by monitoring the shoeprints or footprints, selectively, of said user.

13. In association with a computer operated interactive device having a surface, wherein the interactive device is responsive to contact between its surface and respective persons and objects, and is adapted to selectively display images upon its surface, a computer program product executable in a computer readable medium comprising:
instructions for enabling said interactive device to access specified information pertaining to a user;
instructions for selectively configuring said device for interaction with said user, during a time related to performance of a specified activity by said user;
instructions for using at least some of said specified user information to determine the orientation of said user with respect to a reference position of said surface, at a time related to performance of said specified activity; and
instructions for performing a task that is related to the determined orientation of said user with respect to said reference position of said surface.

14. The computer program product of claim 13, wherein said computer program product includes:
instructions for recording each of a succession of contacts that are applied to said surface by said user, when a user is performing said activity, wherein said contacts collectively comprise a record of said performance.

15. The computer program product of claim 14, wherein:
said task includes selectively adjusting said record of said performance in accordance with said determined orientation of said user, and said adjusted performance record is compared with a prespecified standard of performance.

16. The computer program product of claim 13, wherein:
said configuring of said device includes adjusting real time directions provided to said user in response to one or more size related dimensions of said user, wherein said size related dimensions are included in said specified user information.

17. In association with a computer operated interactive device having a surface, wherein the interactive device is responsive to contact between its surface and respective persons and objects, and is adapted to selectively display images upon its surface, apparatus comprising:
means for enabling said interactive device to access specified information pertaining to a user;
means for selectively configuring said device for interaction with said user, during a time related to performance of a specified activity by said user;
means for using at least some of said specified user information to determine the orientation of said user with respect to a reference position of said surface, at a time related to performance of said specified activity; and
means for performing a task that is related to the determined orientation of said user with respect to said reference position of said surface.

18. The apparatus of claim 17, wherein said apparatus includes:
means for recording each of a succession of contacts that are applied to said surface by said user, when said user is performing said activity, wherein said contacts collectively comprise a record of said performance.

19. The apparatus of claim 18, wherein:
said task includes selectively adjusting said record of said performance in accordance with said determined orientation of said user, and said adjusted performance record is compared with a prespecified standard of performance.

20. The apparatus of claim 17, wherein:
said configuring means includes means for adjusting real time directions in response to one or more size related dimensions of said user, wherein said size related dimensions are included in said specified user information.
